(19) United States
(12) Patent Application Publication
(10) Pub. No.: US 2026/0170352 A1
(43) Pub. Date: Jun. 18, 2026

(54) NEURAL INVERSE-KINEMATICS FOR GAMING AND SYNTHETIC DATA GENERATION

(71) Applicant: Microsoft Technology Licensing, LLC, Redmond, WA (US)

(72) Inventors: Charles Thomas HEWITT, Cambridge (GB); Mohammad Sadegh Ali Akbarian, Cambridge (GB); Louis Antoine Michel Florentin, Bellevue, WA (US); Tadas Baltrusaitis, Cambridge (GB)

(21) Appl. No.: 18/984,552

(22) Filed: Dec. 17, 2024

(51) Int. Cl. G06N 3/0985; A63F 13/20; G06N 3/0455; G06V 10/82; G06V 40/10

(52) U.S. Cl. CPC G06N 3/0985; A63F 13/20; G06N 3/0455; G06V 10/82; G06V 40/11

(57) ABSTRACT

Methods and systems are described for generating plausible hand poses using machine learning techniques that require only three-dimensional fingertip position data, as input. A conditional variational autoencoder is trained using normalized hand pose data to learn a distribution of natural hand poses independent of control signals. The trained decoder generates realistic hand poses by combining latent codes with fingertip position data, without requiring joint rotation information. The generated poses are optimized through an iterative process that maintains anatomical plausibility while satisfying positional constraints. The methods enable real-time generation of natural-looking hand poses for gaming and synthetic data applications. The approach improves upon traditional inverse kinematics by avoiding unnatural joint configurations and awkward wrist orientations. The methods are particularly valuable for virtual reality applications where characters need to grasp objects naturally, and for creating diverse training data for computer vision systems.

### TECHNICAL FIELD

The present disclosure relates generally to computer vision and machine learning systems for generating realistic human hand poses. More particularly, the disclosure relates to methods and systems for generating plausible grasping poses using neural networks and conditional variational autoencoders that require only three-dimensional fingertip position data. The technical field encompasses artificial intelligence, computer graphics, and human-computer interaction, focusing on real-time pose generation for gaming and synthetic data applications. The disclosure describes systems and methods for training neural networks to learn distributions of plausible hand poses and efficiently generate new poses that satisfy positional constraints while maintaining natural hand configurations, enabling compelling gaming experiences and high-quality synthetic training data for computer vision systems.

### BACKGROUND

Realistic modeling and simulation of human motion, particularly the movement and positioning of human hands, is an important aspect of many applications in computer graphics, gaming, virtual reality (VR), and augmented reality (AR). Accurately replicating the intricate movements of the human hand, including its grasping and interacting with objects, is essential for creating immersive experiences and ensuring natural interactions in virtual environments. This challenge extends beyond visual fidelity; the motion must also align with plausible physical constraints and the complex biomechanics of the human anatomy to enhance realism and user engagement.

In addition to real-time applications such as video games and VR environments, the ability to generate realistic human hand poses plays a significant role in machine learning and artificial intelligence. For instance, synthetic data representing human hand poses is often used to train models for object manipulation, gesture recognition, and robotics. High-quality, plausible hand pose data is essential for improving the performance and generalizability of such models. Generating these poses efficiently and realistically requires an understanding of not only the hand's kinematics but also the contextual interactions with objects and environments.

### BRIEF DESCRIPTION OF THE DRAWINGS

Embodiments of the present invention are illustrated by way of example and not limitation in the figures of the accompanying drawings, in which:

FIG. 1 illustrates an example of a hand grasping a mobile device, showing a typical hand pose for object interaction.

FIG. 2 illustrates a sequence showing fingertip position data (top row) and corresponding generated hand poses (bottom row) demonstrating the ability of the system to create plausible grasping poses from position data alone, consistent with some embodiments.

FIG. 3 is a block diagram illustrating the training architecture of a conditional variational autoencoder for generating hand poses, including the pose encoder, latent space distribution, and pose decoder components, consistent with some embodiments.

FIG. 4 is a block diagram illustrating the optimization process for generating final hand poses, showing the flow from initial latent code through pose optimization to final hand pose generation, consistent with some embodiments.

FIG. 5 is a block diagram illustrating a software architecture that can be used to implement the hand pose generation methods described herein.

FIG. 6 is a block diagram illustrating an example machine architecture with which embodiments of the present invention may be implemented.

### DETAILED DESCRIPTION

Described herein are methods and systems for generating plausible hand poses using machine learning techniques that require only three-dimensional fingertip position data. The methods employ a conditional variational autoencoder architecture to learn distributions of natural hand poses and efficiently generate new poses that satisfy positional constraints while maintaining anatomical plausibility. In the following description, numerous specific details are set forth to provide a thorough understanding of the various aspects of different embodiments of the present invention. The methods are particularly applicable to gaming and synthetic data generation applications, where realistic hand poses are needed for character animation and training machine learning models. It will be evident, however, to one skilled in the art, that the present invention may be practiced without all of these specific details and may be extended to other articulated objects beyond hand.

Generating plausible hand poses for gaming and synthetic data generation has traditionally relied on manual artist intervention or standard inverse kinematics approaches that produce anatomically unrealistic results. Current solutions require both joint position and rotation information, making them impractical for many applications. When using standard inverse kinematics, the generated poses often exhibit unnatural finger joint angles, awkward wrist orientations, and implausible relationships between adjacent fingers. The system may generate finger poses where joints bend in anatomically impossible ways, or where the overall hand configuration appears rigid and mechanical rather than natural and fluid. Additionally, existing methods struggle to maintain proper anatomical constraints across the complex kinematic chain of the hand, leading to poses where the relative positioning of joints violates natural hand movement patterns. These issues are particularly noticeable when attempting to generate grasping poses, where fingers may intersect with each other or fail to wrap naturally around objects.

In gaming applications, particularly virtual reality (VR), players need their character's hands to naturally grasp and interact with various objects to maintain immersion. Current template-based approaches lack realism and fail to capture the natural variations in human movement. Motion capture techniques, while more realistic, are time-intensive and costly, limiting their application to a subset of characters.

For synthetic data generation, creating realistic training data showing humans interacting with common objects like mugs, pens, and glasses is crucial for machine learning models. However, existing solutions often produce unnatural poses that can affect unintended body parts, leading to inconsistencies in the generated data. The challenge is particularly acute when generating poses that must satisfy specific constraints while maintaining natural hand configurations.

Previous attempts to address these challenges have relied on complex input requirements, including both joint location and rotation information. This makes such solutions difficult to implement in real-world applications where only position data may be available. Furthermore, existing methods typically produce deterministic results, limiting the diversity and realism of the generated poses.

Consistent with embodiments of the present invention, a technique is provided using a machine learning system for generating realistic hand poses using only three-dimensional fingertip position data, without requiring joint rotation information. The system employs a conditional variational autoencoder architecture that operates in two distinct phases. During the training phase, the training data is prepared from a collection of hand poses by normalizing the poses through standardizing their position and orientation, and generating composite poses by combining portions of different normalized poses. A conditional variational autoencoder is trained using an unconditional encoder that learns a distribution of plausible hand poses independent of control signals, while a conditional decoder learns to generate hand poses based solely on fingertip position data. The training process employs specialized loss functions that ensure both accurate pose reconstruction and proper distribution of the learned latent space.

During the generation phase, the system receives only three-dimensional fingertip position data as input, with no rotation information required. The trained decoder, operating independently of the encoder, generates an initial hand pose by combining a latent code sampled from the learned distribution with the provided fingertip position data. This initial pose undergoes an optimization process that minimizes a specialized cost function, ensuring the final pose both maintains anatomical plausibility while precisely satisfying the input fingertip positions. The system architecture enables real-time generation of natural-looking hand poses, making it particularly valuable for gaming applications where characters need to grasp objects naturally, and for creating diverse training data for computer vision systems.

The innovative approach, which requires only positional data (e.g., fingertip position data), combined with its ability to generate diverse, anatomically plausible poses in real-time, represents a significant advancement over traditional methods that require both position and rotation information. This simplified input requirement, coupled with the efficient optimization process of the system, enables practical implementation across a wide range of applications, from virtual reality gaming to synthetic data generation for machine learning models. Other aspects and advantages of the various embodiments will be readily apparent from the detailed descriptions of the several drawings provided below.

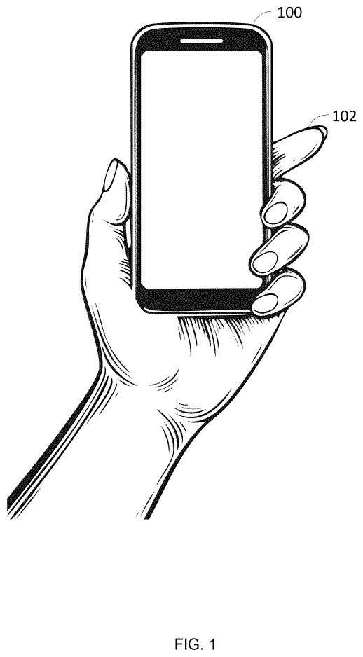

FIG. 1 illustrates an example of a plausible grasping pose, showing a hand 102 grasping a mobile device 100, generated using a technique consistent with an embodiment of the invention. The hand 102 is depicted naturally grasping the mobile device 100 in a way that demonstrates the ability of the innovative techniques set forth herein to create realistic hand poses using only three-dimensional fingertip position data, without requiring joint rotation information. The generated pose exhibits natural joint angles and wrist orientation that would be difficult to achieve using traditional inverse kinematics approaches. This pose exemplifies how, consistent with the techniques set forth herein, a grasping pose of a human hand can maintain anatomical plausibility while precisely positioning the fingertips to achieve a secure and natural-looking grasp of the mobile device. The illustration in FIG. 1 demonstrates capabilities for generating grasping poses that account for both the physical constraints of human hand anatomy and the practical requirements of object interaction, producing results that avoid the unnatural finger configurations and awkward wrist orientations common in previous approaches. This realistic grasping pose is particularly valuable for applications in gaming and virtual reality where natural hand-object interactions are crucial for user immersion.

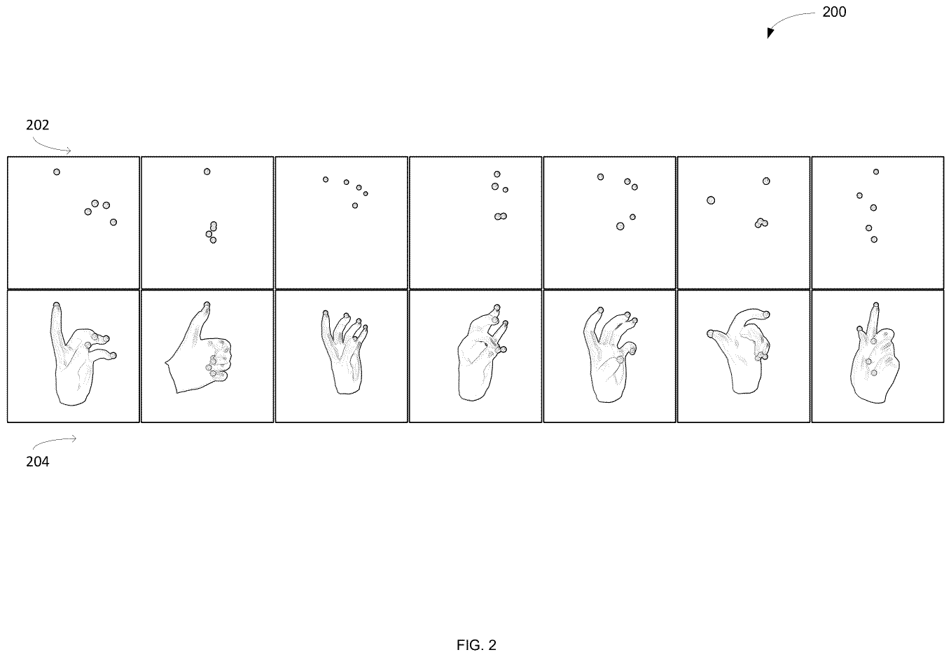

FIG. 2 illustrates a sequence showing fingertip position data (top row 202) and corresponding generated hand poses (bottom row 204) demonstrating the ability of the innovative system to create plausible grasping poses for human hands from fingertip position data alone, consistent with some embodiments. The sequence includes a top row 202 showing different configurations of fingertip position data represented as dots in three-dimensional space. The bottom row 204 shows, for each combination of dots representing fingertips in the top row, the corresponding generated hand poses, as rendered, that satisfy the fingertip position constraints while maintaining natural hand configurations.

Each pair of images in the sequence demonstrates how the same set of fingertip positions can result in a plausible grasping pose, with the generated poses exhibiting natural joint angles and anatomically correct finger configurations. The variety of poses shown—from pinching gestures to spread fingers to closed grasps—illustrates the ability of the system to generate diverse yet realistic hand poses using only sparse positional constraints. This is achieved without requiring any rotation information for the joints, demonstrating how the trained decoder can infer natural joint rotations and wrist orientations solely from the fingertip position data.

The sequence particularly highlights how the system maintains anatomical plausibility while precisely satisfying the positional constraints. Each generated pose shows natural relationships between adjacent fingers, appropriate joint angle limits, and overall hand configurations that would be difficult to achieve using traditional inverse kinematics approaches. The visualization demonstrates the capability of the system to generate poses suitable for both gaming applications, where natural hand-object interactions are crucial, and synthetic data generation, where diverse yet realistic poses are needed for training machine learning models.

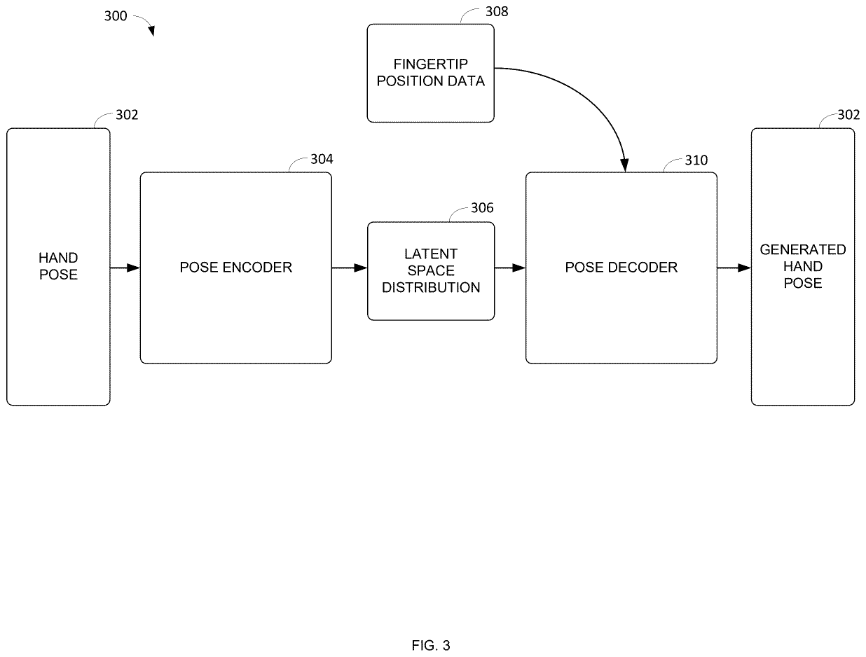

FIG. 3 is a block diagram illustrating the training architecture of a conditional variational autoencoder for generating hand poses, including the pose encoder 304, latent space distribution 306, and pose decoder 310 components, consistent with some embodiments. In some embodiments, the training process begins with obtaining hand pose data from various sources such as motion capture techniques, existing hand pose datasets, or other suitable collections of hand pose data. The training data may be prepared through different normalization approaches—for example, in some embodiments each hand pose may be normalized by adjusting its root joint position to the coordinate system origin and rotating the pose so the root joint faces forward along a consistent axis. Additional training data may be generated by combining portions of different normalized hand poses while maintaining anatomical validity, though other techniques for generating composite hand poses may also be used. For each hand pose used in training, whether normalized or composite, a corresponding three-dimensional hand mesh may be generated based on joint rotations and shape parameters that account for variations in hand dimensions, though other mesh generation techniques may also be suitable. The training data preparation process helps improve model generalization by providing diverse yet anatomically valid training examples.

Once the training data is prepared, consistent with some embodiments, the training of the encoder-decoder architecture begins using an Adam optimizer with a learning rate of 0.001 and mini-batch size of 1024. The pose encoder 304, implemented as a multilayer perceptron (MLP), maps input hand poses to a latent space distribution 306. The encoder receives normalized hand pose data 302 that includes joint rotations, shape parameters, and geometric features extracted from pretrained encoders. The encoder then learns to parameterize a Normal distribution with mean μφ and variance σφ that captures the essential characteristics and natural variations of hand poses.

The pose encoder 304 maps input features into a compressed latent representation through gradient descent optimization. The encoder learns an approximate posterior distribution q0(z|Pt,Ps,G)=N(z;μθ,σθ) that maps the input pose parameters to a Gaussian distribution in the latent space 306. This distribution is regularized using a KL (Kullback-Leibler) divergence loss that ensures the learned distribution stays close to a prior distribution. The mapping process effectively compresses the high-dimensional hand pose data 302 into a lower-dimensional latent code while filtering out anatomically impossible configurations.

Consistent with some embodiments, the learning process is guided by specialized loss functions implemented over 100 training epochs. An L1 reconstruction loss ensures the compressed representation maintains accurate pose parameters and mesh reconstruction, while the KL divergence loss is gradually weighted during training to ensure numerical stability. This gradual weighting, known as KL annealing, starts with a weight of 0 and increases to a maximum value αKL that is less than 1, helping to balance between reconstruction quality and the expressiveness of the learned latent distribution.

The learning process of the pose encoder 304 specifically aims to create an unconditional distribution over plausible hand poses, independent of any control signals or fingertip position constraints. This design choice prevents the learned distribution from being overly constrained by specific pose-control signal combinations seen during training, allowing for greater generalization and flexibility in the generated poses. The resulting latent space 306 serves as a learned prior over anatomically valid hand configurations.

The pose decoder 310, also implemented as an MLP, learns to generate plausible hand poses through a specialized training process that combines latent codes with fingertip position data 308, as a constraint. During training, the pose decoder 310 receives both samples from the latent space distribution 306 and fingertip position data 308 as input. The decoder learns to reconstruct hand poses by combining these inputs to generate anatomically plausible hand configurations that satisfy the positional constraints.

Specifically, the decoder learns the likelihood po(Pt|z,Ps,G), where z is the latent code sampled from the encoder's posterior distribution, Ps represents the fingertip position data, and G contains geometric information about the hand. The decoder is trained using an L1 reconstruction loss that ensures accurate reproduction of both pose parameters and mesh geometry while maintaining the natural hand configurations encoded in the latent space. This conditional training allows the decoder to learn how to map from the latent space to hand poses while respecting the fingertip position constraints.

The decoder's training process is guided by carefully weighted loss functions that balance between pose reconstruction accuracy and satisfaction of the positional constraints. The reconstruction loss ensures the generated poses match the ground-truth poses from the training data, while additional loss terms enforce that the generated poses precisely satisfy the input fingertip positions. The training process continues until meeting defined convergence criteria, enabling the decoder to learn a conditional mapping that can generate diverse yet anatomically plausible hand poses that accurately meet the positional requirements specified by the fingertip data.

While specific training parameters, architectures, and techniques have been described above, these details are provided as examples only and should not be considered limiting. The training process may utilize different optimization algorithms, learning rates, batch sizes, or number of training epochs than those specifically described. Similarly, the neural network architectures for the encoder and decoder may be implemented using various types of network structures beyond multilayer perceptrons. The normalization and data augmentation techniques may also vary, with different approaches possible for standardizing poses and generating composite training examples. The specific loss functions and their weighting schemes may be adjusted based on particular applications and requirements. What remains consistent across different implementations is the core approach of using an unconditional encoder to learn a distribution of plausible poses and a conditional decoder that generates poses based on fingertip position constraints.

After training is complete, the trained decoder can be used independently at inference time to generate plausible hand poses in real-world applications. During the generation phase, the system receives only three-dimensional fingertip position data as input, such as contact points on the surface of a virtual object that a character needs to grasp. This positional data contains no rotation information, making it significantly simpler to specify compared to traditional approaches that require both position and rotation data.

The trained decoder operates by combining randomly sampled latent codes from the learned distribution with the input fingertip position data. Because the decoder learned a conditional mapping during training, it can generate anatomically plausible hand poses that precisely satisfy the positional constraints while maintaining natural joint configurations. This capability is particularly valuable in gaming applications—for example, when a player in a virtual reality game moves to pick up an object, the system can quickly generate a realistic grasping pose based only on the contact points of the object.

A key advantage of this approach is that the decoder can generate diverse yet plausible poses for the same fingertip positions by sampling different latent codes. This non-deterministic behavior helps create more natural and varied hand motions compared to traditional inverse kinematics approaches that would generate the same pose every time. The decoder's ability to operate using only positional data, combined with its real-time performance capabilities, makes it well-suited for interactive applications where natural hand poses need to be generated dynamically based on user actions.

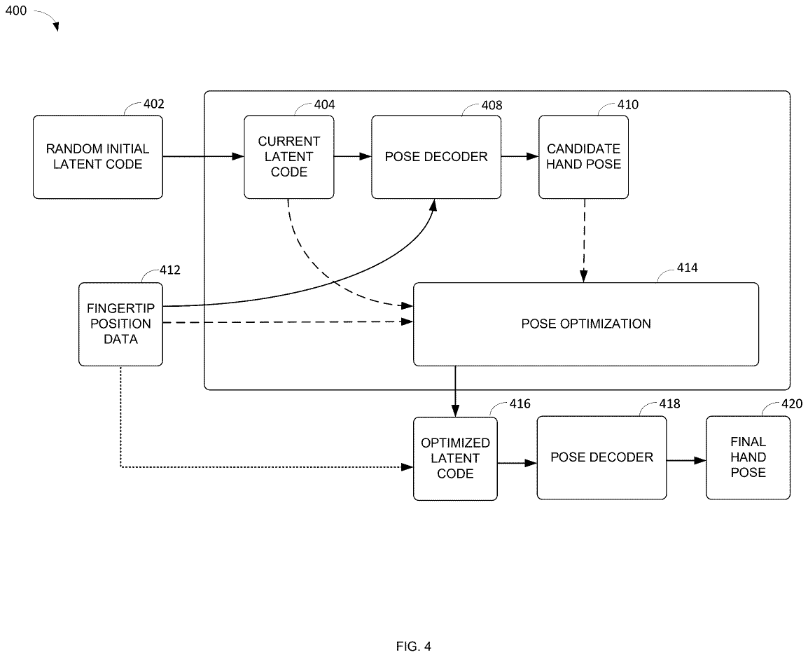

FIG. 4 illustrates a block diagram 400 showing the optimization process for generating final hand poses during inference time. The process begins with a random initial latent code 402 that is sampled from a Gaussian distribution. This initial latent code 402 becomes the current latent code 404 which, along with fingertip position data 412, is passed to the pose decoder 408. The pose decoder 408 generates a candidate hand pose 410 based on these inputs.

The candidate hand pose 410 and current latent code 404 then undergo an optimization process in the pose optimization block 414. This optimization minimizes a specialized cost function that combines two key components: a prior loss term that ensures the latent code remains within the learned distribution of plausible poses, and a control signal loss term that enforces accuracy between the generated pose and the input fingertip positions. Consistent with some embodiments, the optimization process uses Limited memory BFGS with a history size of 10, learning rate of 1, and Strong-Wolfe line search to iteratively refine the latent code.

The pose optimization block 414 implements a specialized cost function C that combines two key components: C=WpLprior(zi)+WcLsignal(θi,c), where:
Lprior represents the prior loss that ensures the latent code zi remains within the learned distribution
Lsignal represents the control signal loss that enforces accuracy between the generated pose θi and the input fingertip positions c
Wp and Wc are weighting parameters that balance the two loss terms

Consistent with some embodiments, the optimization process uses Limited memory BFGS with a history size of 10, learning rate of 1, and Strong-Wolfe line search to iteratively minimize this cost function. The prior loss term Lprior helps maintain pose plausibility by penalizing latent codes that deviate too far from the distribution learned during training. The control signal loss term Lsignal uses an L1 loss to measure the distance between the generated fingertip positions and the target positions specified in the input data. This dual-objective optimization ensures the final pose both satisfies the positional constraints while maintaining the natural hand configurations encoded in the latent space.

Once the optimization converges, the process outputs an optimized latent code 416. This optimized code, together with the original fingertip position data 412, is passed through the pose decoder 418 one final time to generate the final hand pose 420. A key advantage of this approach is that the initial pose produced by the decoder is typically already close to a valid solution, making the optimization process highly efficient and often requiring only a few iterations to converge to a high-quality result. The optimization framework ensures that the final pose both satisfies the positional constraints while maintaining the natural hand configurations learned during training.

In real-time applications like gaming and virtual reality, the trained decoder with optimization can be integrated directly into the application pipeline to generate hand poses dynamically. For example, when a player reaches to grasp a virtual object, the system first determines the contact points on the surface of the object where the fingertips should be positioned. These three-dimensional contact points are then provided as input to the trained system, which rapidly generates a natural-looking hand pose through the optimization process described above.

The ability of the system to operate in real-time stems from several key technical advantages. First, because the decoder has learned a distribution of plausible poses during training, the initial pose generated from a random latent code is typically already close to a valid solution. This means the optimization process often requires only a few iterations to converge to a high-quality result. Additionally, the system can generate multiple plausible variations of a pose by sampling different latent codes, allowing for natural variation in how characters interact with objects. This is particularly valuable in gaming scenarios where repetitive, identical motions would reduce immersion.

The optimization framework ensures that even under real-time constraints, the generated poses maintain both physical plausibility and precise positioning. As the player's virtual hand moves through the environment, the system continuously updates the fingertip position constraints and generates new poses that smoothly transition between different grasping configurations. This creates fluid, natural-looking interactions that enhance the user experience while maintaining the performance requirements of real-time applications.

While the techniques described herein have been illustrated primarily in the context of generating hand poses, some embodiments may be extended to other types of articulated objects that have differentiable parametric models. For example, the same approach of learning pose distributions from positional constraints could be applied to generating poses for robotic arms, full human bodies, or other articulated structures with kinematic joint hierarchies. The core methodology of using an unconditional encoder to learn a distribution of plausible configurations, combined with a conditional decoder that generates poses based on sparse positional constraints, remains applicable across different types of articulated objects.

The ability to extend these techniques beyond hand poses is particularly valuable for applications like full-body animation in games or generating training data for computer vision systems that need to recognize diverse human poses. Just as with hand poses, the system can generate anatomically plausible full-body configurations using only key positional constraints like hand and foot positions, without requiring complete joint rotation information. This generalization capability stems from the fundamental approach of learning natural pose distributions and using optimization to satisfy positional constraints while maintaining plausibility.

### Machine and Software Architecture

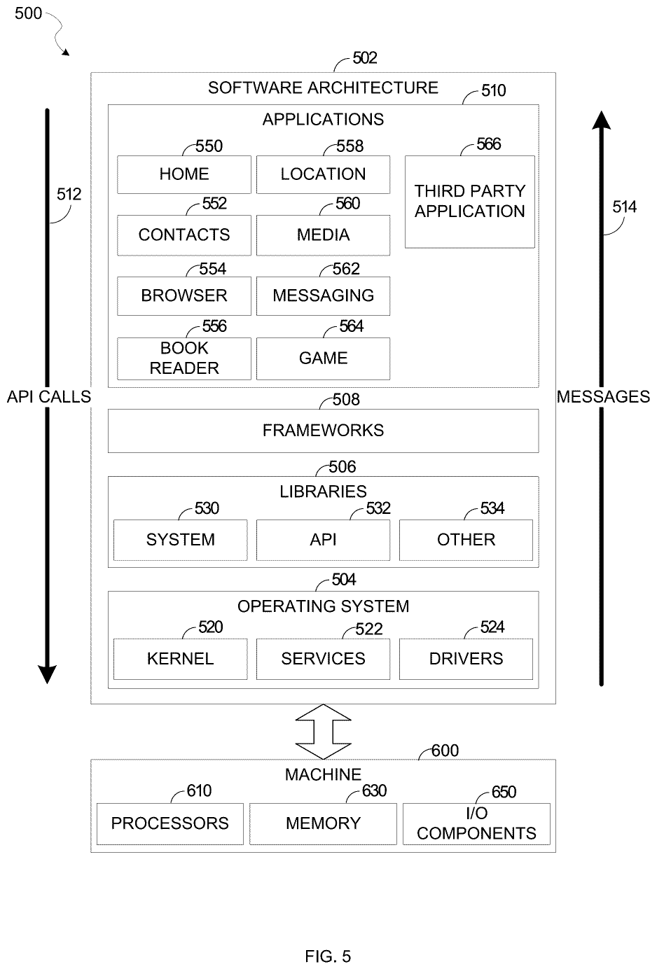

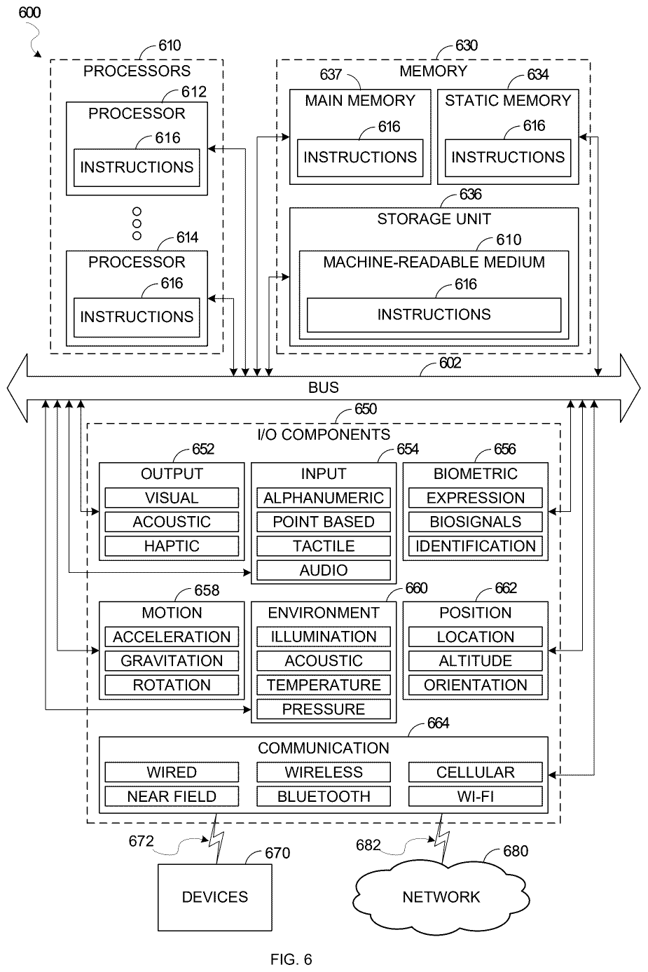

FIG. 5 is a block diagram 500 illustrating a software architecture 502, which can be installed on any of a variety of computing devices to perform methods consistent with those described herein. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 605 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions 616 may cause the machine 600 to execute any one of the methods or algorithmic techniques described herein. Additionally, or alternatively, the instructions 616 may implement any one of the systems described herein. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors that may comprise two or more independent processors (sometimes referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 632, a static memory 634, and a storage unit 636, all accessible to the processors 610 such as via the bus 602. The main memory 630, the static memory 634, and storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 662 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672, respectively. For example, the communication components 664 may include a network interface component or another suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or storage unit 636 may store one or more sets of instructions and data structures (e.g., software) embodying or utilized by any one or more of the methodologies or functions described herein. These instructions (e.g., the instructions 616), when executed by processor(s) 610, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A method for generating a grasping pose for a human hand, the method comprising:
training a conditional variational autoencoder by:
preparing training data from hand pose data for a collection of hand poses by normalizing hand poses through standardizing position and orientation relative to a reference frame and generating composite hand poses by combining portions of different normalized poses;
configuring an unconditional encoder to learn a distribution of hand poses independent of control signals;
configuring a conditional decoder to generate hand poses based on fingertip position data and without hand pose rotational data; and
training the encoder and decoder with the training data using one or more loss functions that enforce hand pose reconstruction accuracy and latent space distribution constraints; and
generating the grasping pose for the human hand by:
receiving three-dimensional position data for fingertips of a human hand, wherein the three-dimensional position data excludes rotation information;
generating, using the trained conditional decoder, the grasping pose based on:
a latent code from the learned distribution of hand poses, and
the received fingertip position data; and
outputting the generated grasping pose for the human hand.

2. The method of claim 1, wherein preparing the training data comprises:
normalizing the hand poses by:
centering root joints of each hand pose at an origin, and
standardizing orientations of the hand poses to face a consistent direction;
generating the composite hand poses by replacing portions of kinematic joint structures from one normalized hand pose with corresponding portions from another normalized hand pose; and
generating for each normalized and composite hand pose a corresponding three-dimensional hand mesh as a function of:
joint rotations from the hand pose, and
shape parameters that define variations in hand sizes and proportions.

3. The method of claim 1, wherein training the encoder and decoder comprises:
training the encoder and decoder using:
a reconstruction loss that enforces accuracy between generated and ground-truth hand poses; and
a Kullback-Leibler divergence loss that constrains the latent distribution, wherein the Kullback-Leibler divergence loss is gradually weighted during training to ensure numerical stability.

4. The method of claim 3, wherein training the encoder and decoder further comprises:
applying an L1 loss between predicted pose parameters and ground-truth pose parameters;
applying an L1 loss between generated hand meshes and ground-truth hand meshes;
gradually increasing a weight of the Kullback-Leibler divergence loss from zero to a maximum value less than one; and
optimizing encoder and decoder parameters using an iterative optimization process with a learning rate selected to ensure convergence, mini-batches of training data, and multiple training iterations until a convergence criterion is met.

5. The method of claim 1, further comprising:
optimizing the generated hand pose by:
minimizing a cost function comprising:
a prior loss term that maintains the hand pose within the learned distribution, and a control signal loss term that ensures the hand pose satisfies the fingertip position data; and
outputting the optimized hand pose using the optimized latent code.

6. The method of claim 1, wherein generating the grasping pose comprises:
initializing a latent code from a random distribution;
iteratively optimizing the latent code by:
passing the latent code and fingertip position data through the trained conditional decoder to generate a candidate hand pose, and
minimizing a cost function that combines:
a prior loss that constrains the latent code to remain within the learned distribution, and
a control signal loss that enforces accuracy between the candidate hand pose and the received fingertip position data; and
generating the final grasping pose by passing the optimized latent code and the fingertip position data through the trained conditional decoder.

7. The method of claim 1, wherein receiving the three-dimensional position data comprises:
receiving a selection of a virtual object in a game environment;
determining contact points on a surface of the selected virtual object for fingertip placement; and
generating the three-dimensional position data based on the determined contact points; and
generating the grasping pose comprises:
generating a hand pose for a game character to grasp the selected virtual object;
wherein the generated hand pose varies based on a position of the game character relative to the virtual object, and a current position of a wrist of the game character controlled by a user.

8. A system for generating a grasping pose for a human hand, the system comprising:
at least one processor; and
at least one memory storage device storing instructions thereon, which, when executed by the at least one processor, causes the system to perform operations comprising:
training a conditional variational autoencoder by:
preparing training data from hand pose data for a collection of hand poses by normalizing hand poses through standardizing position and orientation relative to a reference frame and generating composite hand poses by combining portions of different normalized poses;
configuring an unconditional encoder to learn a distribution of hand poses independent of control signals;
configuring a conditional decoder to generate hand poses based on fingertip position data and without hand pose rotational data; and
training the encoder and decoder with the training data using one or more loss functions that enforce hand pose reconstruction accuracy and latent space distribution constraints; and
generating the grasping pose for the human hand by:
receiving three-dimensional position data for fingertips of a human hand, wherein the three-dimensional position data excludes rotation information;
generating, using the trained conditional decoder, the grasping pose based on:
a latent code from the learned distribution of hand poses, and
the received fingertip position data; and
outputting the generated grasping pose for the human hand.

9. The system of claim 8, wherein preparing the training data comprises:
normalizing the hand poses by:
centering root joints of each hand pose at an origin, and
standardizing orientations of the hand poses to face a consistent direction;
generating the composite hand poses by replacing portions of kinematic joint structures from one normalized hand pose with corresponding portions from another normalized hand pose; and
generating for each normalized and composite hand pose a corresponding three-dimensional hand mesh as a function of:
joint rotations from the hand pose, and
shape parameters that define variations in hand sizes and proportions.

10. The system of claim 8, wherein training the encoder and decoder comprises:
training the encoder and decoder using:
a reconstruction loss that enforces accuracy between generated and ground-truth hand poses; and
a Kullback-Leibler divergence loss that constrains the latent distribution, wherein the Kullback-Leibler divergence loss is gradually weighted during training to ensure numerical stability.

11. The system of claim 10, wherein training the encoder and decoder further comprises:
applying an L1 loss between predicted pose parameters and ground-truth pose parameters;
applying an L1 loss between generated hand meshes and ground-truth hand meshes;
gradually increasing a weight of the Kullback-Leibler divergence loss from zero to a maximum value less than one; and
optimizing encoder and decoder parameters using an iterative optimization process with a learning rate selected to ensure convergence, mini-batches of training data, and multiple training iterations until a convergence criterion is met.

12. The system of claim 8, wherein the operations further comprise:
optimizing the generated hand pose by:
minimizing a cost function comprising:
a prior loss term that maintains the hand pose within the learned distribution, and a control signal loss term that ensures the hand pose satisfies the fingertip position data; and
outputting the optimized hand pose using the optimized latent code.

13. The system of claim 8, wherein generating the grasping pose comprises:
initializing a latent code from a random distribution;
iteratively optimizing the latent code by:
passing the latent code and fingertip position data through the trained conditional decoder to generate a candidate hand pose, and
minimizing a cost function that combines:
a prior loss that constrains the latent code to remain within the learned distribution, and
a control signal loss that enforces accuracy between the candidate hand pose and the received fingertip position data; and
generating the final grasping pose by passing the optimized latent code and the fingertip position data through the trained conditional decoder.

14. The system of claim 8, wherein receiving the three-dimensional position data comprises:
receiving a selection of a virtual object in a game environment;
determining contact points on a surface of the selected virtual object for fingertip placement; and
generating the three-dimensional position data based on the determined contact points; and
generating the grasping pose comprises:
generating a hand pose for a game character to grasp the selected virtual object;
wherein the generated hand pose varies based on a position of the game character relative to the virtual object, and a current position of a wrist of the game character controlled by a user.

15. One or more memory storage devices storing instructions thereon, which, when executed by at least one processor, cause a system to perform operations comprising:
training a conditional variational autoencoder by:
preparing training data from hand pose data for a collection of hand poses by normalizing hand poses through standardizing position and orientation relative to a reference frame and generating composite hand poses by combining portions of different normalized poses;
configuring an unconditional encoder to learn a distribution of hand poses independent of control signals;
configuring a conditional decoder to generate hand poses based on fingertip position data and without hand pose rotational data; and
training the encoder and decoder with the training data using one or more loss functions that enforce hand pose reconstruction accuracy and latent space distribution constraints; and
generating the grasping pose for the human hand by:
receiving three-dimensional position data for fingertips of a human hand, wherein the three-dimensional position data excludes rotation information;
generating, using the trained conditional decoder, the grasping pose based on:
a latent code from the learned distribution of hand poses, and
the received fingertip position data; and
outputting the generated grasping pose for the human hand.

16. The one or more memory storage devices of claim 15, wherein preparing the training data comprises:
normalizing the hand poses by:
centering root joints of each hand pose at an origin, and
standardizing orientations of the hand poses to face a consistent direction;
generating the composite hand poses by replacing portions of kinematic joint structures from one normalized hand pose with corresponding portions from another normalized hand pose; and
generating for each normalized and composite hand pose a corresponding three-dimensional hand mesh as a function of:
joint rotations from the hand pose, and
shape parameters that define variations in hand sizes and proportions.

17. The one or more memory storage devices of claim 15, wherein training the encoder and decoder comprises:
training the encoder and decoder using:
a reconstruction loss that enforces accuracy between generated and ground-truth hand poses; and
a Kullback-Leibler divergence loss that constrains the latent distribution, wherein the Kullback-Leibler divergence loss is gradually weighted during training to ensure numerical stability.

18. The one or more memory storage devices of claim 17, wherein training the encoder and decoder further comprises:
applying an L1 loss between predicted pose parameters and ground-truth pose parameters;
applying an L1 loss between generated hand meshes and ground-truth hand meshes;
gradually increasing a weight of the Kullback-Leibler divergence loss from zero to a maximum value less than one; and
optimizing encoder and decoder parameters using an iterative optimization process with a learning rate selected to ensure convergence, mini-batches of training data, and multiple training iterations until a convergence criterion is met.

19. The one or more memory storage devices of claim 15, wherein the operations further comprise:
optimizing the generated hand pose by:
minimizing a cost function comprising:
a prior loss term that maintains the hand pose within the learned distribution, and a control signal loss term that ensures the hand pose satisfies the fingertip position data; and
outputting the optimized hand pose using the optimized latent code.

20. The one or more storage devices of claim 15, wherein generating the grasping pose comprises:
initializing a latent code from a random distribution;
iteratively optimizing the latent code by:
passing the latent code and fingertip position data through the trained conditional decoder to generate a candidate hand pose, and
minimizing a cost function that combines:
a prior loss that constrains the latent code to remain within the learned distribution, and
a control signal loss that enforces accuracy between the candidate hand pose and the received fingertip position data; and
generating the final grasping pose by passing the optimized latent code and the fingertip position data through the trained conditional decoder.
